(19) United States
(12) Patent Application Publication
(10) Pub. No.: US 2026/0166355 A1
(43) Pub. Date: Jun. 18, 2026

(54) Hand-Held Fire Extinguisher Assembly

(71) Applicant: Safermind Technologies, LLC, Clearwater Beach, FL (US)

(72) Inventors: Thomas Hudak, Sarasota, FL (US); Jeremiah Friend, Burbank, OH (US); John P. Cichello, Wooster, OH (US); Michael Berry, Wooster, OH (US)

(21) Appl. No.: 18/982,434

(22) Filed: Dec. 16, 2024

(51) Int. Cl. A62C 13/64; A62C 13/78; F21V 33/00; A62C 37/50

(52) U.S. Cl. CPC A62C 13/64; A62C 13/78; F21V 33/0064; A62C 37/50

(57) ABSTRACT

A hand-held fire extinguisher assembly. The fire extinguisher assembly includes a shroud that includes an enclosed interior space. A fire extinguisher is positioned within the interior space of the shroud. The fire extinguisher includes a tank configured to contain extinguishing agent, a nozzle that extends from the tank through which the extinguishing agent is expelled with the nozzle extending outward from the interior space of the shroud, and a trigger positioned on an exterior of the shroud with the trigger connected to the fire extinguisher to selectively expel the extinguishing agent through the nozzle.

### TECHNICAL FIELD

The present application is directed to a hand-held fire extinguisher and, more specifically, to a hand-held fire extinguisher assembly that includes a shroud that extends around and encloses a fire extinguisher.

### BACKGROUND

A fire can double in size every minute. Therefore it is important to extinguish the fire in its incipient stage prior to allowing it to reach an uncontrollable size. A basic tool in stopping a fire is a fire extinguisher. The fire extinguisher is sized to be easily lifted and handled by most people. The fire extinguisher includes a trigger that is activated by the user and a nozzle that is pointed towards the fire to expel the extinguishing agent and extinguish the fire. In some examples, the fire extinguisher has pins and related attachments that make it more complicated and harder to deploy and/or operate. Despite universal acknowledgement of the importance of fire extinguishers, there are still many reasons why many homes and businesses are not equipped with a fire extinguisher.

Some people do not have a fire extinguisher at their home or business because it is not aesthetically attractive. A fire extinguisher usually includes a tank with a cylindrical shape that holds the extinguishing agent, and a trigger that is squeezed to dispel the extinguishing agent. Some people find the appearance to be poor and therefore do not have a fire extinguisher in their home/office. This is particularly an issue because fire extinguishers are usually positioned in a kitchen/breakroom which are often a focal point of a home/office and have been upfit to have a particular appearance.

In some instances, fire extinguishers are located in a home/office. However, the fire extinguishers are stored in locations that are hard to access. For example, a fire extinguisher is positioned in the back of a cabinet behind other items. In the event of a fire, it would be difficult and time consuming to access the fire extinguisher in a timely manner to enable the user to fight the fire. This extra time may allow the fire to grow in size.

Improving the visual appearance would increase the number of people who would have a fire extinguisher in their home/office. This would enable a user to place the fire extinguisher in a position where it can be readily accessed in the event of a fire. The manner of improving the visual appearance should not interfere with the functionality of the fire extinguisher.

### SUMMARY

One aspect is directed to a fire extinguisher assembly comprising a shroud that comprises an enclosed interior space. A fire extinguisher is positioned within the interior space of the shroud, the fire extinguisher comprises: a tank configured to contain extinguishing agent; a nozzle that extends from the tank through which the extinguishing agent is expelled with the nozzle extending outward from the interior space of the shroud; and a trigger positioned on an exterior of the shroud with the trigger connected to the fire extinguisher to selectively expel the extinguishing agent through the nozzle.

In another aspect, an actuation assembly is positioned within the interior space and connected to the tank with the actuation assembly comprising a stem that is biased by a spring to a closed position.

In another aspect, the trigger is operatively connected to the actuation assembly and movable between a first position and a second position with the first position locating the stem to prevent the extinguishing agent from moving through the nozzle and the second position locating the stem to enable the extinguishing agent to move through the nozzle.

In another aspect, a light is connected to the shroud at a light opening with the light configured to illuminate and be visible on an exterior of the shroud.

In another aspect, each of the light, the trigger, and the nozzle are exposed on an exterior of the shroud.

In another aspect, the shroud comprises a top, a bottom, and sidewalls that extend around and form the interior space, wherein at least one of the top and the bottom are solid.

In another aspect, the fire extinguisher assembly weights between 2-8 pounds.

In another aspect, the tank is completely enclosed within the interior space and is visually obscured from an exterior of the shroud.

In another aspect, the shroud comprises multiple sections that are connected together and form the enclosed interior space.

In another aspect, a control unit is positioned within the interior space with the control unit comprising processing circuitry configured to control a light connected to the shroud.

In another aspect, at least one battery is positioned within the interior space with the at least one battery configured to power a light that is connected to the shroud.

In another aspect, a docking station comprises a base configured to receive a bottom of the shroud, electrical contacts, and a plug configured to connect to an electrical supply.

One aspect is directed to a fire extinguisher assembly comprising a fire extinguisher comprising: a tank configured to contain extinguishing agent; and a nozzle that extends from the tank and that includes an end through which the extinguishing agent is expelled. A shroud that extends around and completely encloses the tank. A trigger extends through the shroud and is connected to the fire extinguisher to selectively expel the extinguishing agent through the nozzle.

In another aspect, the nozzle extends through the shroud.

In another aspect, a light is mounted to the shroud and visible on an exterior of the shroud.

In another aspect, a control unit is positioned within the interior space with the control unit comprising processing circuitry configured to control the light.

In another aspect, the control unit further comprises communications circuitry configured to communicate with a remote node

In another aspect, a docking station comprises: a base configured to receive a bottom of the shroud; electrical contacts; and a plug configured to connect to an electrical supply.

In another aspect, a control unit is positioned within the base of the docking station with the control unit comprising processing circuitry configured to monitor a status of the fire extinguisher.

One aspect is directed to a fire extinguisher assembly comprising: a hand-held fire extinguisher that contains an extinguishing agent; a shroud that extends completely around the fire extinguisher; and a trigger that extends through the shroud and is connected to the fire extinguisher to selectively expel the extinguishing agent.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of a front side of a fire extinguisher assembly that includes a fire extinguisher positioned within a shroud.

FIG. 1A is a sectional view of the fire extinguisher assembly taken along line II-II of FIG. 1.

FIG. 2 is an isometric view of a rear side of a fire extinguisher assembly that includes a fire extinguisher positioned within a shroud.

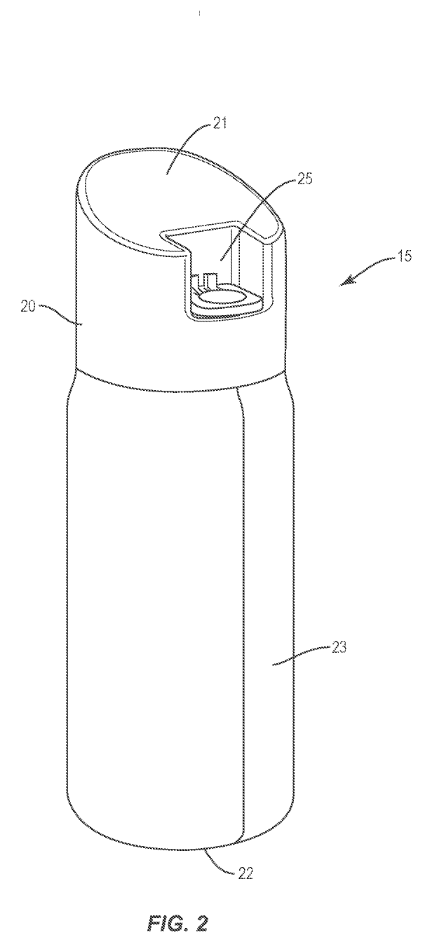

FIG. 3 is an exploded view of a shroud that is constructed from three separate sections that are configured to be connected together.

FIG. 4 is an isometric view of a connector configured to engage with a plug to provide electrical power to the fire extinguisher assembly.

FIG. 5 is an isometric view of a docking station configured to engage with a fire extinguisher assembly.

FIG. 6 is an isometric view of electrical contacts positioned on a bottom of a shroud and configured to engage with a docking station.

FIG. 7 is a schematic diagram of a control unit of a fire extinguisher assembly.

FIG. 8 is a schematic diagram of a control unit of a remote server.

FIG. 9 is a schematic diagram of a communication network.

### DETAILED DESCRIPTION

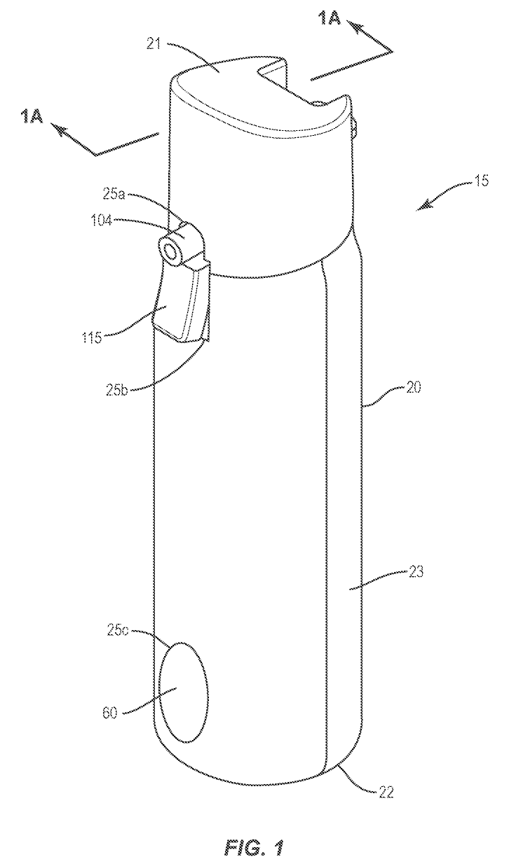

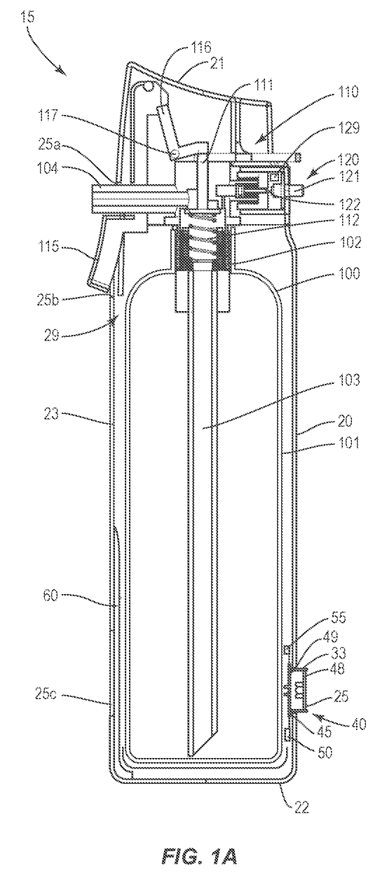

FIGS. 1 and 1A illustrate a fire extinguisher assembly 15. The fire extinguisher assembly 15 includes a fire extinguisher 100 configured to be used to fight a fire. The fire extinguisher assembly 15 also includes a shroud 20 that extends around the fire extinguisher 100. The shroud 20 is configured to protect the fire extinguisher 100 and provide an aesthetically attractive look.

The fire extinguisher assembly 15 is sized and configured to be lifted and handled by a person to fight a fire. This hand-held fire extinguisher assembly 15 includes various sizes for use by people with different physical abilities. In some examples, the first extinguisher 100 weighs between 2-8 pounds. In two specific examples, a first fire extinguisher assembly 15 weights about 2 pounds, and a second fire extinguisher assembly 15 weight about 6 pounds.

The fire extinguisher 100 includes a tank 101 configured to contain an extinguishing agent. The tank 101 can include various shapes and sizes, with one specific example having a cylindrical shape. The tank 101 includes an outlet 102 through which the extinguishing agent is expelled during use. In some examples as illustrated in FIG. 1A, the outlet 102 is positioned at a top of the tank 101 when in an upright orientation. A tube 103 extends into the tank 101 at the outlet 102. A bottom end of the tube 103 is positioned at the bottom of the tank 101. A nozzle 104 is in communication with the tube 103 and extends outward from the outlet 102. During use, extinguishing agent enters the tube 103, moves along the length and into the nozzle 104 where it is expelled through the distal end.

An actuation assembly 110 enables a user to selectively expel the extinguishing agent. The actuation assembly 110 includes a stem 111 that is positioned at the outlet 102 to control the flow of extinguishing agent. The stem 111 is biased by a spring 112 to a closed position that prevents the extinguishing agent from moving into the nozzle 104. A trigger 115 extends through the shroud 20 to enable a user to expel the extinguishing agent. The trigger 115 contacts against a bracket 116 that is positioned within the shroud 20. The bracket 116 in turn contacts against the stem 111. When the trigger 115 is activated by a user, the movement causes the bracket 116 to pivot about point 117. This movement causes the stem 111 to be forced downward and overcome the force applied by the spring 112 to expel the extinguishing agent through the outlet 104. Release of the trigger 115 by the user causes a reverse movement with the stem 111 moving to a position that prevents release of the extinguishing agent. In some examples, the force of the spring 112 acting on the stem 111 maintains the trigger 115 in an outward position that prevents expelling the extinguishing agent.

In some examples, a release mechanism 120 is positioned to enable activation of the actuation assembly 110. The release mechanism 120 secures the actuation assembly 110 in a locked position that prevents the extinguishing agent from moving into the nozzle 104. The locked position prevents movement of the stem 111 from the position that blocks the extinguishing agent. In some examples as illustrated in FIG. 1A, the release mechanism 120 includes a plunger 121 and an electrical switch 122. In some examples, the release mechanism 120 includes a pin 124. The pin 124 mechanically engages with the actuation assembly 110 to lock the actuation assembly 110. Priming includes removal of the pin 124 by the user that enables the actuation assembly 110 to be activated through the trigger 115 to expel the extinguishing agent.

In some examples, one or more sensors 129 detect the state of the fire extinguisher 100. In some examples, the one or more sensors 129 detects the pressure within the tank 101. In some examples, the one or more sensors 129 detects the state of the release mechanism 120.

In some examples, a mechanical pressure switch is exposed through an opening 25 in the shroud 20. The pressure switch is positioned to be actuated when the fire extinguisher assembly 15 is positioned in a storage position, such as when the bottom is resting on the ground or within a docking station 30. When the pressure switch is actuated, electrical sensing of the pressure within the tank 101 occurs. When the pressure switch is not actuated, such as when the fire extinguisher assembly 15 is in use, the pressure switch is not actuated and the pressure is not sensed.

The shroud 20 forms an interior space 29 that receives the fire extinguisher 100. The shroud 20 extends around the fire extinguisher 100 and generally includes a top 21, bottom 22, and side walls 23. The top 21 extends over the top of the actuation assembly 110 and top of the tank 101. The bottom 22 extends across the bottom of the tank 101. The side walls 23 extend over the lateral sides of the tank 101 and actuation assembly 110. The shroud 20 can be constructed from a variety of materials, including but not limited to polycarbonates, polymers, and plastics. In some examples, the shroud 20 is constructed from a rigid material. This provides for the shroud 20 to protect the fire extinguisher 100. The rigid material also facilitates grasping and handling by the user.

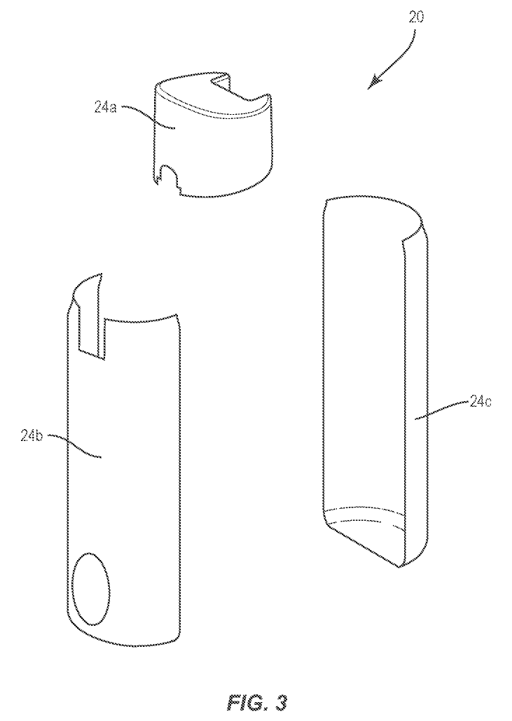

In some examples, the shroud 20 is a single piece that is formed around the fire extinguisher 100. In other examples, the shroud 20 includes two or more sections 24 that are connected together to enclose the fire extinguisher 100. In one example as illustrated in FIG. 3, the shroud 20 is constructed from three separate sections 24a, 24b, 24c. The sections 24 are configured to connect together. The sections 24 can be connected together in various manners including but not limited to adhesives, frictional fits, and mechanical fasteners. The modular design enables the different sections 24 to be placed around the fire extinguisher 100 and then connected together to form the shroud 20.

The shroud 20 extends around and visually hides the fire extinguisher 100 thus providing an attractive aesthetic appearance. The shroud 20 also protects the fire extinguisher 100 as it forms a protective shield that prevents damage to the various components including the actuation assembly 110 and the tank 101.

The shroud 20 includes one or more openings 25 positioned and sized to enable use of the fire extinguisher 100. FIG. 1 illustrates an example with a first opening 25a at the nozzle 104 and a second opening 25b at the trigger 105. In some examples, the openings 25a, 25b are separate. In some examples, a single opening is sized and configured to accommodate both of the nozzle 104 and trigger 105. The shroud 20 can include various other openings. Examples include but are not limited to one or more openings 25 for a light 60, pin 124, and charging components. A remainder of the shroud 20 includes solid, continuous walls.

In some examples, the first extinguisher assembly 15 includes one or more lights 60. In some examples, a light 60 is positioned on a front side of the shroud 20 in proximity to the nozzle 104 as illustrated in FIG. 1. The light 60 is configured to illuminate in different colors. In some examples, the different colors represent the pressure within the interior of the tank 101. In some examples, the light 60 is green when the tank has a pressure above a predetermined threshold and red when the pressure is below the threshold. In other examples, the different colors depend upon the level of charge of an internal battery, or whether the fire extinguisher assembly 15 is docked into a docking station or connected to a charger. In some examples, the light 60 is configured to illuminate in three or more different colors.

In some examples, the light 60 is bright enough to act as a beacon for a user to locate the fire extinguisher assembly 15 during low light or darkened conditions. In some examples, the light 60 is configured to illuminate an area when the fire extinguisher assembly 15 is being handled by a user. For example, the light 60 illuminates a darkened stairway or hallway.

In some examples as illustrated in FIG. 1, the front of the fire extinguisher assembly 15 includes the nozzle 104, the trigger 115, and the light 60. In some examples, the connector 40 is positioned on an opposite side (i.e., the back) of the fire extinguisher assembly 15. When the fire extinguisher assembly 15 is positioned in an area such as a kitchen or office, the light 60 is visible with the electrical connector 40 being hidden from view.

In some examples, a light 60 is positioned to emit a light beam from the front of the fire extinguisher assembly 15 in the direction that the nozzle 104 is pointed. This facilitates a user using the fire extinguisher assembly 15 in a low-light condition. In some examples, the light 60 is positioned at an opening 25 in proximity to the nozzle 104. The light 60 is configured to emit the light beam when it is removed from the docking station 30 and/or plug 150.

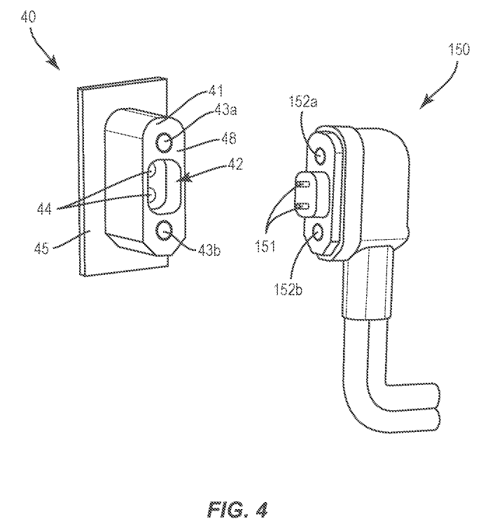

A power source 55 provides power to one or more of the components of the fire extinguisher assembly 15. The power source 55 can include various configurations, including but not limited to one or more rechargeable batteries. Power is supplied to the power source 55 in a variety of different manners. In some examples as illustrated in FIGS. 1A and 4, an electrical connector 40 is mounted in an opening 25 in the shroud 20. The connector 40 is configured to connect to an external plug 150. The connector 40 includes a body 41 with an inner side 49 that is mounted on a circuit board 45. The body 41 also includes an outer side 48 aligned in the opening 25 and exposed to connect to the plug 150. The outer side 48 includes a receptacle 42 sized to engage with the plug 150. Contacts 44 at the bottom of the receptacle 42 engage with corresponding contacts 151 on the plug 150. Magnets 43 are mounted to and exposed on the outer side 48 body 41 and engage with magnets 152 on the plug 110. The magnets 43a, 152a and magnets 43b, 152b have reverse polarities to ensure that plug 150 engages with the connector 40 in the correct orientation. The connector 40 is electrically connected to the power source 55.

In the example of FIGS. 1A and 4, the fire extinguisher assembly 15 is stored in an area in proximity to the plug 150. This enables the connector 40 and plug 150 to remain engaged when the fire extinguisher assembly 15 is not in use.

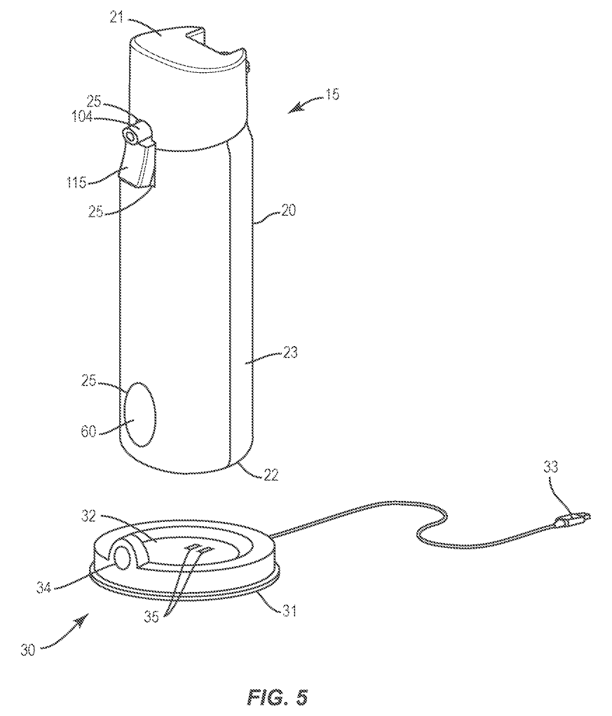

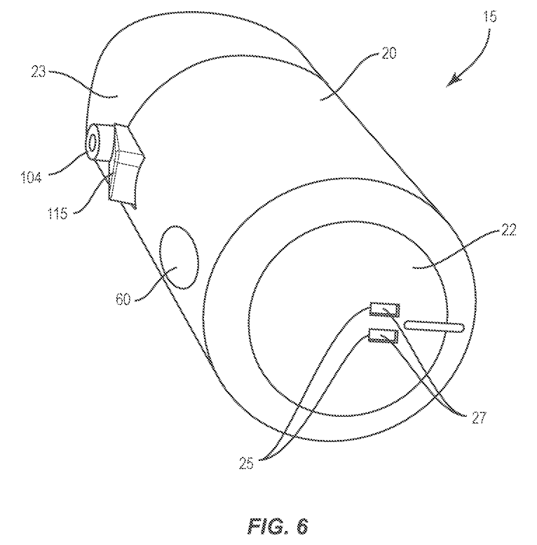

In some examples as illustrated in FIGS. 5 and 6, the fire extinguisher assembly 15 is charged through a docking station 30. The docking station 30 includes a base 31 with a receptacle 32 sized to receive the bottom 22 of the shroud 20. Electrical contacts 35 on the receptacle 32 contact against corresponding electrical contacts 27 that are exposed at openings 25 on the bottom 22 of the shroud 20. When the fire extinguisher assembly 15 is positioned on the base 31, the electrical contacts 27, 35 contact together and enable charging of the power source 55. The docking station 33 also includes a plug 33 that is configured to connect to an electrical supply such as the wiring installed with a house or office.

The electrical contacts 27, 35 contact together when the fire extinguisher assembly 15 is positioned on the docking station 30. In some examples, one or both of the electrical contacts 27, 35 are biased outward to facilitate the engagement. In some examples, one or both are magnetic and spring-loaded to facilitate the contact.

In some examples as illustrated in FIG. 5, the docking station 30 includes a light 34 on the base 31. The light 34 facilitates finding the fire extinguisher assembly 15 in low light conditions.

In some examples, the various electrical inputs provide low voltage DC power to the fire extinguisher assembly 15. In one specific example, the electrical input provides 5VDC power.

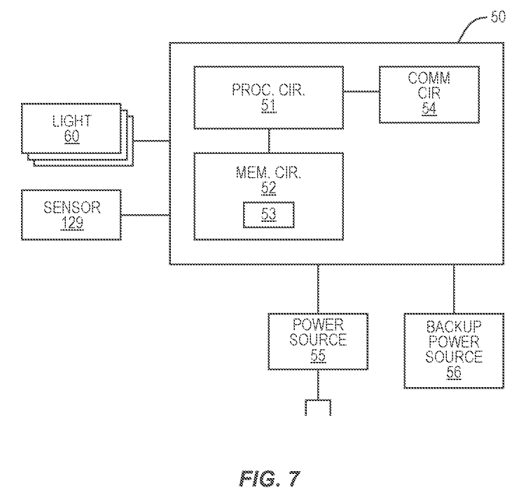

A control unit 50 is configured to monitor the fire extinguisher assembly 15. In some examples, the control unit 50 is mounted within the interior space 29. In other examples, the control unit 50 is mounted within the docking station 30. As illustrated in FIG. 7, the control unit 50 includes processing circuitry 51 and a memory circuitry 52. The control circuit 121 can include one or more circuits, microcontrollers, microprocessors, hardware, or a combination thereof. Memory circuit 52 includes a non-transitory computer readable storage medium storing program instructions 53, such as a computer program product, that configures the processing circuitry 51 to implement one or more of the techniques discussed herein. Memory circuitry 52 can include various memory devices such as, for example, read-only memory, and flash memory. Memory circuitry 52 can be a separate component or can be incorporated with the processing circuitry 51.

Communications circuitry 54 provides for communication functionality for the fire extinguisher assembly 15. The communications circuit 54 can provide for different methods of communication and can include one or more of a cellular interface that enables communication with a mobile communication network, and a WLAN interface configured to communicate with a local area network. In one example, the communications circuitry 54 is incorporated into the control unit 50. In another example, the communications circuitry 54 is a separate system that is operatively controlled by the processing circuitry 51. The communication circuitry 54 can further include a personal area network interface, such as a Bluetooth interface, and a Near Field Communication interface that provides for short-range wireless connectivity technology that uses magnetic field induction to permit devices to share information with each other over short distances.

The power source 55 provides power to the control unit 50 as well as components within the fire extinguisher assembly 15 (e.g., lights 60). The power source 55 can be incorporated within the control unit 50 or can be separate and electrically connected to and control unit 50. In some examples, a backup power source 56 provides power in the event of an issue with the main power source 55. In some examples, the backup power source 56 includes one or more batteries (e.g., AAA batteries) that are stored within the interior space 29.

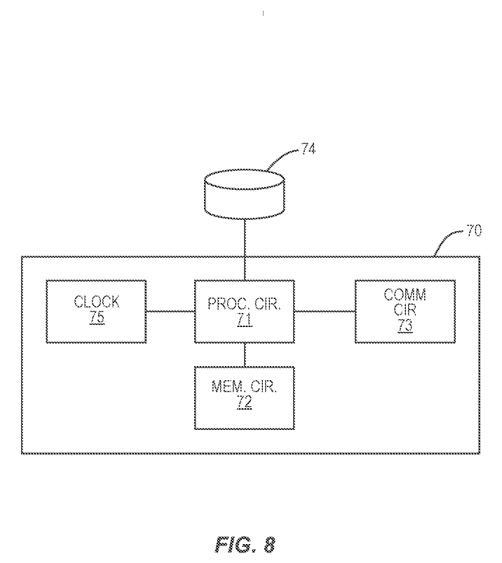

In some examples as illustrated in FIG. 8, a remote server 70 monitors the fire extinguisher assembly 15. The remote server 70 can monitor various aspects, including but not limited to the pressure within the tank 101, whether the actuation assembly 110 has been actuated, whether the fire extinguisher assembly 15 is mounted to the docking station 30, and the charge of the power source 55 and/or backup power source 56. The server 70 can communicate with the user to provide the status of the fire extinguisher assembly 15.

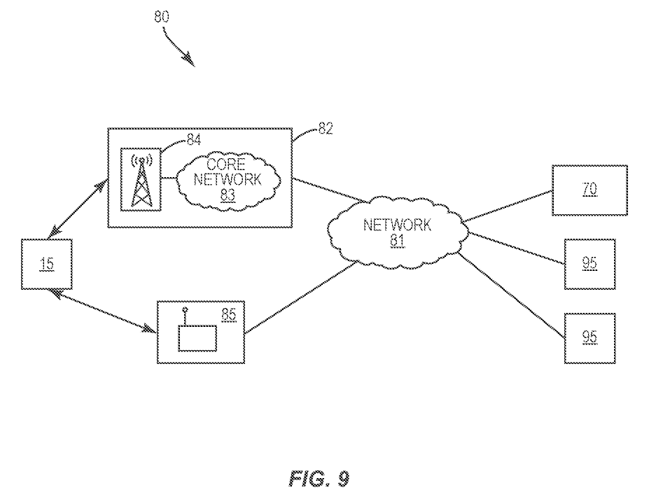

The remote server 70 monitors and communicates with the fire extinguisher assembly 15 through a wireless communications network 80 as illustrated in FIG. 9. The communications circuitry 54 of the fire extinguisher assembly 15 enables communication with the server 70 through the wireless communications network 80.

The wireless communication network 80 can include a packet data network (PDN) 81. The PDN 81 can include a public network such as the Internet, or a private network. The wireless communications network 80 can include a mobile communication network 82 (e.g., a WCDMA, LTE, or WiMAX network). The mobile communication network (MCN) 82 includes a core network 83 and a radio access network (RAN) 84 including one or more base stations. The MCN 82 can be a conventional cellular network operating according to any communication standards now known or later developed. For example, the MCN 82 can comprise a Wideband Code Division Multiple Access (WCDMA) network, a Long Term Evolution (LTE) network, or WiMAX network. The MCN 82 is further configured to access the packet data network (PDN) 81.

The communications circuitry 54 can also communicate through a Wireless Local Area Network (WLAN) 85 that operates according to the 802.11 family of standards, which is commonly known as a WiFi interface.

As illustrated in FIG. 8, the server 70 includes one or more processing circuits (illustrated as processing circuitry 71) that may include one or more microprocessors, microcontrollers, Application Specific Integrated Circuits (ASICs), or the like, configured with appropriate software and/or firmware. A computer readable storage medium (shown as memory circuitry 72) stores data and computer readable program code that configures the processing circuitry 71 to implement the techniques described above. Memory circuitry 72 is a non-transitory computer readable medium and may include various memory devices such as random-access memory, read-only memory, and flash memory. Communications circuitry 73 connects the server 70 to the PDN 81 and can be configured to communicate with the PDN 81 according to one or more 802.11 standards. The communications circuitry 73 can support a wired connection (e.g., Ethernet), a wireless connection, or both. A database 74 stores information about the fire extinguisher assembly 15. The database 74 is stored in a non-transitory computer readable storage medium (e.g., an electronic, magnetic, optical, electromagnetic, or semiconductor system-based storage device). The database 74 can be local or remote relative to the server 70. A clock 75 can measure various timing requirements such as time since last recharge, time since last checkup, time that the fire extinguisher assembly 15 was removed from the docking station 30, etc. The clock 75 can be incorporated with the processing circuitry 71 or can be a separate component independent from the processing circuitry 71.

The server 70 can be configured to provide a web interface for access by one or more entities, such as the user. The server 70 is configured for accessing information about the fire extinguisher assembly 15 using a browser-based interface or an applications program interface (API). The browser-based interface can include a website through which the contents of the database 74 can be accessible. Although the website can be hosted by the server 70, it can also be hosted at another location accessible through the PDN 81.

Entities can access the information at the server 80 through a variety of devices 95. The devices 95 can include laptop computers, personal computers, personal digital assistants, mobile computing/communication, tablet devices, and various other-like computing devices. Each of the entities uses a respective device 95 and accesses the server 70 through the PDN 81, or alternatively some other network. In some examples, one or more of the entities can use his or her respective device 95 to access the server 70 through a separate portal. Each entity’s portal can include a secure interface through which the entity can access the information that is assigned to them.

A variety of different entities through their devices 95 can have access to some or all of the information at the server 70. One example is the user that enables determining aspects about the fire extinguisher assembly 15. Another example is the police/fire department that can access the information in the event of a fire. In another example, a home monitoring service is able to monitor the fire extinguisher assembly 15.

In some examples, the server 70 is configured for browser-based accessibility. The browser-based interface can support well-known browsers such as Internet Explorer and Mozilla Firefox, Safari, Chrome. Alternatively, or in conjunction the entities can obtain the information using one or more APIs through their device 95.

In some examples when the fire extinguisher assembly 15 is not in use it is connected to a power source. In some examples that include a connector 40 as illustrated in FIG. 1A, the connector 40 is engaged with a plug 150. In some examples, the first extinguisher assembly 15 is positioned in the docking station 30 with the electrical leads in contact to provide electrical power. In some examples when the first extinguisher assembly 15 is not in use, one or more lights 60 are illuminated. This enables a user to more readily find the fire extinguisher assembly 15 in the event of a fire. In some examples, one or more of the lights 60 further indicate the status of the fire extinguisher 100.

During a fire, a user grabs the fire extinguisher assembly 15 and removes it from the plug 150 and/or docking station 30. In some examples, this causes one or more of the lights 60 to be illuminated. The lights 60 can also illuminate the surroundings to facilitate movement of user. For example, the one or more lights 60 assist when the user is carrying the fire extinguisher assembly 15 through a dark room.

The server 70 monitors the status and use of the fire extinguisher assembly 15. In some examples, a signal is periodically sent from the fire extinguisher assembly 15 and/or docking station 30 indicating the status. The signaling can occur at periodic intervals and/or in the event of a change in the status. For example, a signal is sent when the fire extinguisher assembly 15 is removed from the plug 150 and/or docking station 30. A signal can be sent due to other events such as but not limited to the power source 55 being below a predetermined level, and a pressure in the tank 101 being below a predetermined level. In some examples, the server 70 sends a periodic status check based on a predetermined time frequency.

The server 70 monitors the fire extinguisher assembly 15. In some examples, the server 70 notifies the user in the event of an issue (e.g., when the pressure in the tank 101 falls below a predetermined level). The notification can be through various mediums such as text or email, or through the fire extinguisher assembly 15 or docking station. In one specific example, one or more of the lights 60 are illuminated in a particular color when there is an issue and the user is to contact the server 70.

In some examples, the server 70 contacts emergency personnel during one or more events. In one example, the server 70 contacts the local fire department when the fire extinguisher assembly 15 is removed from the docking station 30.

In some examples, electrical power is supplied to the fire extinguisher assembly 15 through one of a docking station 30 and a connector 40. The electrical power enables operation of the various electrical components including but not limited to lights 60 and the control unit 50. In some examples, the various electrical inputs provide low voltage DC power to the fire extinguisher assembly 15. In one specific example, the electrical input provides 5VDC power.

In some examples, one or more of the electrical components such as but not limited to one or more of the lights 60 are configured to be activated when the fire extinguisher assembly 15 is removed from the docking station 30 and/or plug 150. In another example, one or more mechanical switches are positioned on the exterior of the shroud 20. The switches can be moved between on and off positions by a user. This enables the user to control when one or more of the lights 60 are on.

In some examples, one or more of the lights 60 are connected to a sensor that detects an amount of ambient light. The sensor enables the one or more lights 60 to be on (i.e., illuminated) when the amount of light is below a threshold, such as at night. The sensor also causes the one or more lights 60 to be off when the amount of light is above a threshold, such as during daylight hours. This sensor helps to prevent unwanted discharge of a power source 55 by the one or more lights during times when the light is not necessary.

In some examples, one or more of the lights 60 are powered through electrical power supplied by the docking station 30 and/or plug 40 when the fire extinguisher assembly 15 is electrically connected. This can occur when the fire extinguisher assembly 15 is in a stored position and not in use. The one or more lights 60 are powered through the power source 55 when the fire extinguisher assembly 15 is not receiving power through the docking station 30 and/or plug 40, such as when it is in use and being carried by a user.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are second ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A fire extinguisher assembly comprising:
a shroud that comprises an enclosed interior space;
a fire extinguisher positioned within the interior space of the shroud, the fire extinguisher comprising:
a tank configured to contain extinguishing agent;
a nozzle that extends from the tank through which the extinguishing agent is expelled, the nozzle extending outward from the interior space of the shroud; and
a trigger positioned on an exterior of the shroud, the trigger connected to the fire extinguisher to selectively expel the extinguishing agent through the nozzle.

2. The first extinguisher assembly of claim 1, further comprising an actuation assembly positioned within the interior space and connected to the tank, the actuation assembly comprising a stem that is biased by a spring to a closed position.

3. The first extinguisher assembly of claim 2, wherein the wherein the trigger is operatively connected to the actuation assembly and movable between a first position and a second position, the first position locating the stem to prevent the extinguishing agent from moving through the nozzle, the second position locating the stem to enable the extinguishing agent to move through the nozzle.

4. The first extinguisher assembly of claim 1, further comprising a light connected to the shroud at a light opening, the light configured to illuminate and be visible on an exterior of the shroud.

5. The first extinguisher assembly of claim 4, wherein each of the light, the trigger, and the nozzle are aligned along a common vertical line of the shroud.

6. The first extinguisher assembly of claim 1, wherein the shroud comprises a top, a bottom, and sidewalls that extend around and form the interior space, wherein at least one of the top and the bottom are solid.

7. The first extinguisher assembly of claim 1, wherein the fire extinguisher assembly weights between 2-8 pounds.

8. The first extinguisher assembly of claim 1, wherein the tank is completely enclosed within the interior space and is visually obscured from an exterior of the shroud.

9. The fire extinguisher assembly of claim 1, wherein the shroud comprises multiple sections that are connected together and form the enclosed interior space.

10. The fire extinguisher of claim 1, further comprising a control unit positioned within the interior space, the control unit comprising processing circuitry configured to control a light connected to the shroud.

11. The fire extinguisher of claim 1, further comprising at least one battery positioned within the interior space, the at least one battery configured to power a light that is connected to the shroud.

12. The fire extinguisher of claim 1, further comprising a docking station comprising:
a base configured to receive a bottom of the shroud;
electrical contacts; and
a plug configured to connect to an electrical supply.

13. The fire extinguisher of claim 12, further comprising contacts that are positioned on the shroud and that engage with the electrical contacts on the docking station with the engagement between the contacts and the electrical contacts configured to supply 5VDC power.

14. A fire extinguisher assembly comprising:
a fire extinguisher comprising:
a tank configured to contain extinguishing agent;
a nozzle that extends from the tank and that includes an end through which the extinguishing agent is expelled;
a shroud that extends around and completely encloses the tank; and
a trigger that extends through the shroud and is connected to the fire extinguisher to selectively expel the extinguishing agent through the nozzle.

15. The fire extinguisher assembly of claim 12, further comprising a light mounted to the shroud and visible on an exterior of the shroud.

16. The fire extinguisher assembly of claim 15, further comprising a control unit positioned within the interior space, the control unit comprising processing circuitry configured to control the light.

17. The fire extinguisher assembly of claim 16, wherein the control unit further comprises communications circuitry configured to communicate with a remote node.

18. The fire extinguisher of claim 12, further comprising a docking station comprising:
a base configured to receive a bottom of the shroud;
electrical contacts; and
a plug configured to connect to an electrical supply.

19. The fire extinguisher assembly of claim 18, further comprising a control unit positioned within the base of the docking station, the control unit comprising processing circuitry configured to monitor a status of the fire extinguisher.

20. A fire extinguisher assembly comprising:
a hand-held fire extinguisher that contains an extinguishing agent;
a shroud that extends completely around the fire extinguisher; and
a trigger that extends through the shroud and is connected to the fire extinguisher to selectively expel the extinguishing agent.
